(19) United States
(12) Patent Application Publication
(10) Pub. No.: US 2014/0366497 A1
(43) Pub. Date: Dec. 18, 2014

(54) AIR FILTRATION MODULE FOR COATED SEED PLANTERS

(71) Applicant: JPS AG, LLC, St. Louis Park, MN (US)

(72) Inventors: Jeffrey David NOACK, Eden Prairie, MN (US); Peter James RUPERT, North Oaks, MN (US); Stephen Gerard MAY, St. Louis Park, MN (US)

(73) Assignee: JPS AG, LLC, St. Louis Park, MN (US)

(21) Appl. No.: 14/273,101

(22) Filed: May 8, 2014

Related U.S. Application Data
(60) Provisional application No. 61/835,868, filed on Jun. 17, 2013.

(51) Int. Cl. A01C 7/20; B01D 46/00

(52) U.S. Cl. CPC A01C 7/20; B01D 46/00
USPC 55/385.1

(57) ABSTRACT

An air filtration module has a filter cartridge that contains a filter media to filter out and contain current seed treatment products that contain neonicotinoids. The module takes the place of the porous seed container wall through which compressed air is discharged out the seed hopper air discharge chute

### FIELD OF THE INVENTION

The invention relates to the planting of insecticide-coated seeds, and more particularly to, filtering and containment of insecticides that rub off insecticide-treated seeds that become airborne contaminates that are discharged from an agricultural production planting unit.

### BACKGROUND OF THE INVENTION

In the past, planted seeds have been treated with insecticides and other chemicals by tractor drawn sprayers. Obviously, this method of treatment resulted in the expensive insecticides and chemicals becoming significantly airborne and detrimental to the habitat and life of useful insects, like bees, that are needed to pollinate corn, soybeans and other agriculturally grown food products.

More recently, over 90% of the corn and 80% of the soybeans are being treated with a coating of products that extend the time that seeds can be in the ground before insects and fungus keeps them from germinating. One component of the seed treatment is a neonicotinoid insecticide.

These current seed treatment products have reduced the amount of crop protection products that need to be applied to a crop, such as by spraying. As a result, this has increased the yield of these crops, reduced costs and produced more abundant and cheaper food.

Recently it has been reported that neonicotinoids are causing bees to die when the compound becomes airborne during planting. Bees are necessary to pollinate corn and soybean plants. The European Union is so concerned about this that they have put a 2 year ban on seed treatment products that contain a neonicotinoid coating.

FIGS. 1 through 4 illustrate a wheeled seed planter 10 as is generally known. Coated seeds are usually loaded into the bulk seed hopper by an auger which is located on the front of the planter 10. The planter has a seed hopper box 12 with a cover 14. A compressed air discharge head 16 is within the hopper box 12. Seed is moved into the hopper box 12 via compressed air discharge head 16 from bulk seed hoppper. A porous seed container wall 18 allows the compressed air to move through and vibrate the seeds in the hopper box 12 to the seed tube and discharge chute 24 while the compressed air discharge chute 20 allows the force air to escape the hopper 12. A planter 10 may have a number of laterally disposed seed discharger stations with all the above component for planting multiple rows of seeds at one time.

As can be seen in FIGS. 2 through 4, the blue seed coating material (including neonicotinoids, fungicides, etc.) is all over the hopper 12 and the air discharge chute. The coating material also gets on the underside of the tractor and planter as in FIG. 4. Hence the bee poisonous material substantially contaminates the surrounding atmosphere.

There is a need for a product that greatly reduces the air contamination caused by neonicotinoids vibrating off seeds and blowing into the environment.

### SUMMARY OF INVENTION

An air filtration module has a filter cartridge that contains a filter media to filter out and contain current seed treatment products that contain neonicotinoids. The module takes the place of the porous seed container wall through which compressed air is discharged out the seed hopper air discharge chute.

A principal object and advantage of the present invention is that substantially all seed coatings, including the bee harmful neonicotinoids, are filtered and contained in the module and not discharged into the atmosphere.

Another object and advantage is that the module does not require any construction changes to existing seed planters.

Another object and advantage is that the module is inexpensive to manufacture.

Another object and advantage is that the module will increase the survival rate of bees from poisoning.

Another object and advantage is that the module is that it is easily replaced without tools with a new module while in the field actually planting.

Another object and advantage of the present invention is that more bees will be kept alive and that will allow for this generation of seed treatment products (coating of neonictinoids) to stay on the market which will increase the yields of corn and soybeans.

Another object and advantage is that this invention will increase the amount of food that is available for consumers.

### BRIEF DESCRIPTION OF THE DRAWINGS

FIG. 1 illustrates a side elevational line drawing of a wheeled seed planter as is generally known;

FIG. 2 illustrates a top perspective view of the opened seed hopper showing the hopper air discharge chute contaminated with blue seed coating that has vibrated off the seeds in the hopper during planting;

FIG. 3 also illustrates a top perspective view of the opened seed hopper showing the hopper air discharge chute contaminated with blue seed coating that has vibrated off the seeds in the hopper during planting;

FIG. 4 illustrates a bottom view under the wheeled planter and tractor contaminated with blue seed coating that has vibrated off the seeds and blown out of the hopper through the air discharge chute in the hopper during planting;

FIG. 5 is a perspective view of the module filter cartridge;

Table 1 illustrates a 67% reduction in neonicotinioids that become airborne as a result of using the present invention;

FIG. 6 is another perspective view of the module filter cartridge;

FIG. 7 is a CAD drawing of the filter cartridge;

FIG. 8 is a front elevational view of the filter cartridge with the filter media partially inserted; and

FIG. 9 is another front elevational view of the filter cartridge with the filter media partially inserted.

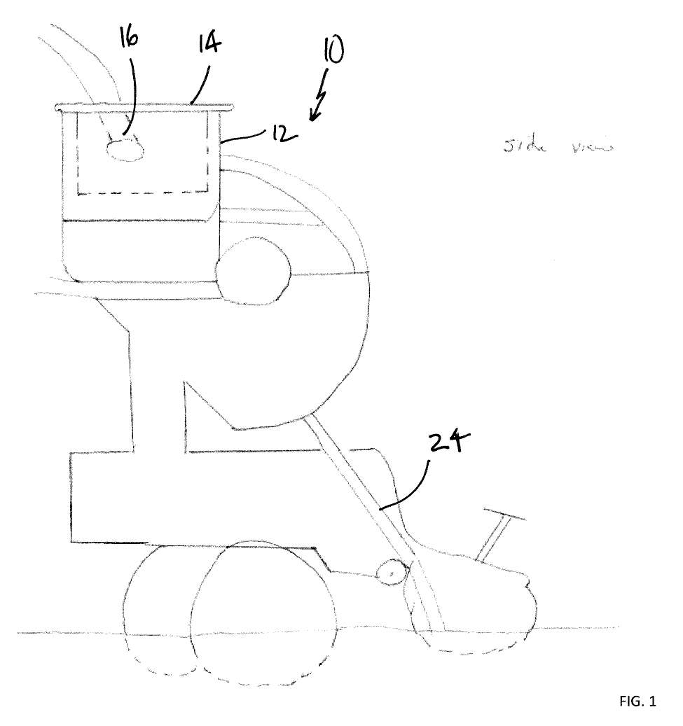

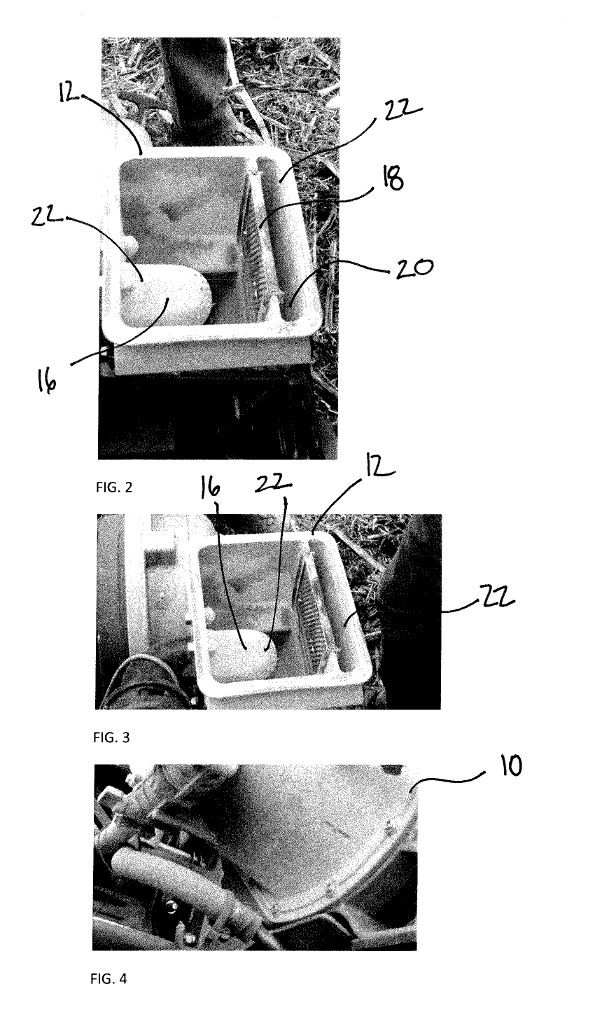

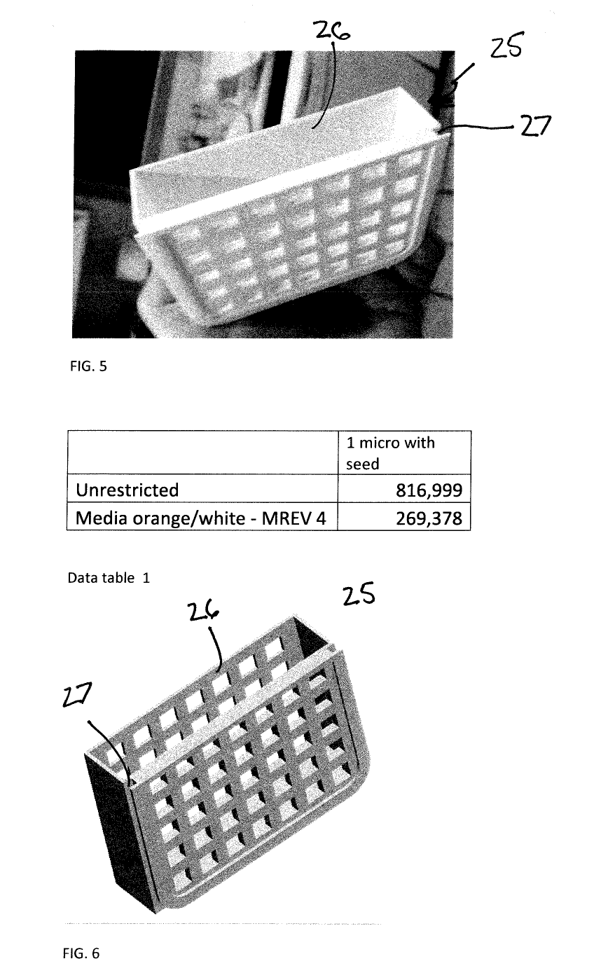

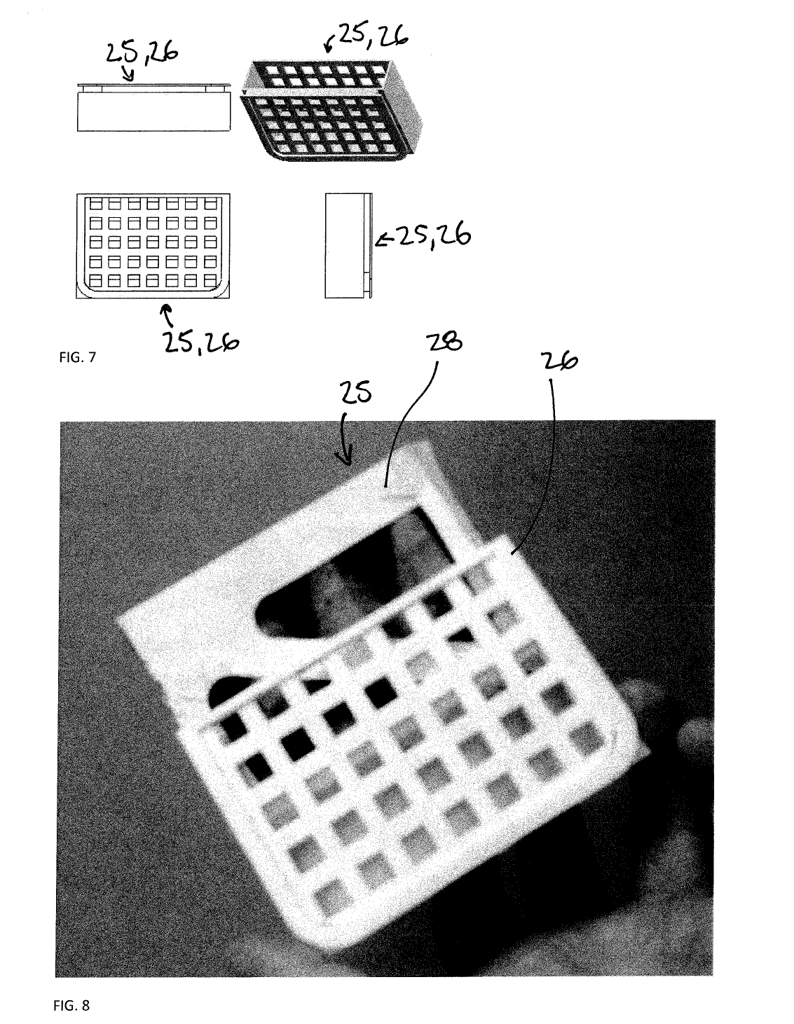

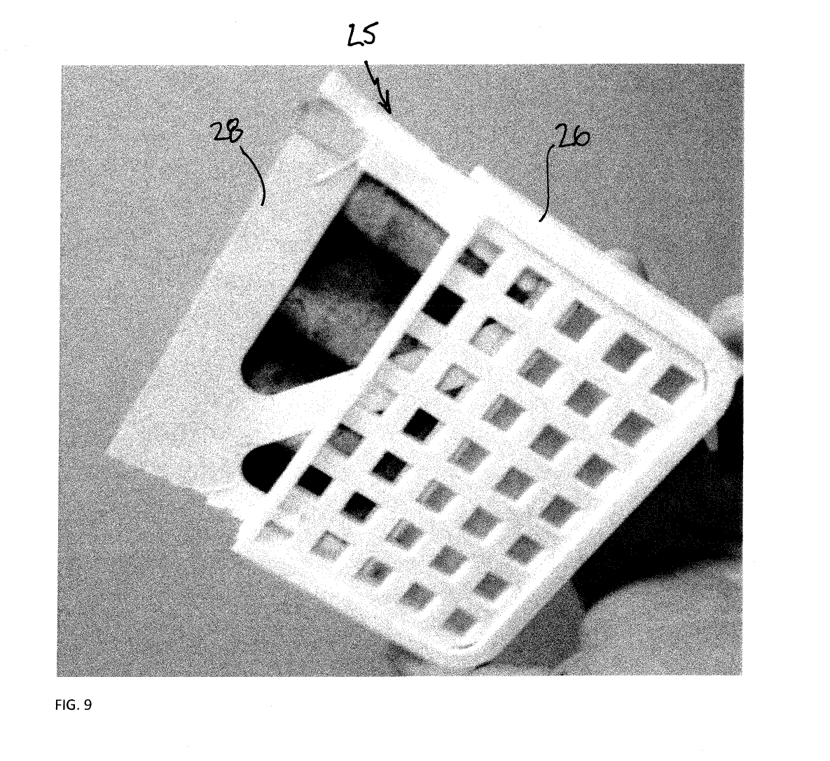

### Detailed Specification

The air filtration module 25 is suitably molded of a thermoweight or thermoplastic plastic into a cartridge or box 26 with open front and back grid walls. The cartridge 26 has a lip around the inside that will help hold the media 28 in place. The cartridge 26 has grooves 27 on its opposing sides to aid in easy indexing and securement into the seed hopper 12. These grooves 27 will allow for easy application to many seed planter hoppers.

In operation, the hopper 12 has its cover 14 removed. the porous seed container wall 18, through which compressed air is discharged, is removed by lifting upwardly. The air filtration module 25, which is the same size as the air discharge wall 18, is inserted in place. When the module becomes clogged with powdered seed coatings 22, the media 28 within cartridge 26 or the whole cartridge 26 is simply replaced in the field.

This module 25 will reduce the amount of contaminated air that develops when neonicotinoid dust becomes airborne. The dust is created when the corn and soybean seeds rubs against the equipment in a planter hopper 12. Data Table 1 one documents a 67% reduction in neonicotinoids that become airborne as a result of using this new technology. MERV 8 media may be as it satisfies ASHARE 52.2.2007 and is UL rated 900. Care should be taken to optimize the amount of airflow but yet be sturdy enough to maintain the integrity of the media 28.

The box or cartridge 28 and media have been developed for maximum air filtration, durability, ease of use and installation. The process of taking plastic and having it molded into a frame that will house the filter is critical to the process. The top of the cartridge 26 may also have lid that will reduce bi-pass air. Air pressure from the seed box 26 will press the air filter 28 against the inside lip. This will make sure that the filter 28 stays in place.

This invention has been developed to diffuse the potential impact that neonicotinoids are having on the pollinating of corn and soybeans. The invention is using air filtration on a corn and soybean planter to reduce the amount of harmful contaminates that get released into the environment. Growers can remove the current screen that is only intended to keep corn and soybean from leaving the seed box or hopper and replace it with the air filtration module 25.

1. An air filtration module has a filter cartridge that contains a filter media to filter out and contain current seed treatment products that contain neonicotinoids. The module takes the place of the porous seed container wall through which compressed air is discharged out the seed hopper air discharge chute.
